(19) United States
(12) Patent Application Publication
(10) Pub. No.: US 2008/0308075 A1
(43) Pub. Date: Dec. 18, 2008

(54) AUTOMOTIVE FUEL SYSTEM FOR SUBSTANTIALLY REDUCING HYDROCARBON EMISSIONS INTO THE ATMOSPHERE, AND METHOD

(76) Inventors: Christopher D. Allen, Eastpointe, MI (US); James T. Dumas, Clinton Township, MI (US); Donald L. Gepper, Commerce Township, MI (US)

Correspondence Address: Joseph V. Tassone, Esq.;DAYCO PRODUCTS, LLC, 1 Prestige Place, Miamisburg, OH, 45342, US

(21) Appl. No.: 11/762,304

(22) Filed: Jun. 13, 2007

(51) Int. Cl. F02M 33/08

(52) U.S. Cl. 123/519

(57) ABSTRACT

An evaporative emissions system is used in an automotive evaporative emission system including a fuel tank coupled to an automotive engine to control emission of fuel vapors to the atmosphere. The system includes an evaporative emissions canister comprising a first molded housing having a circumferential side member, a top member and a bottom member; a hydrocarbon-adsorbing material disposed therein so as to provide a vapor adsorbent chamber for adsorbing hydrocarbon fuel vapor flowing therethrough; and an auxiliary housing containing a carbon-coated reticulated material, the reticulated housing located in the fresh air line of the evaporative emissions canister for preventing fuel vapor molecules from passing through the carbon-coated reticulated material while allowing the air molecules to pass therethrough. A method is provided for preventing or reducing hydrocarbon emissions to the atmosphere.

### BACKGROUND OF THE INVENTION

The present invention relates to a fuel system for an internal combustion engine; particularly, to an evaporation emissions system and for preventing or substantially reducing the emission of hydrocarbon pollutants into the atmosphere; and most particularly, to an improved evaporative emissions system having an external module containing a carbon-coated foam material which acts as a filter media to prevent or substantially reduce the emission of hydrocarbon fuel pollutants to the atmosphere. The module containing the carbon-coated foam material is external with respect to the evaporative emissions canister and, more particularly, in the path of fresh air entering or exiting the emissions canister.

Evaporative emissions result from any one of several events which includes venting of fuel vapors from the fuel tank due to diurnal changes in ambient pressure and/or temperatures (known in the art as “diurnal” emissions), by refueling of the vehicle (known in the art as “refueling” emissions) or by vaporization of fuel by a hot engine and/or exhaust. The venting of fuel vapor from the fuel tank due to diurnal pressure and/or temperature (diurnal emission), and the escape of fuel vapor during refueling (refueling emissions) are responsible for a majority of the emissions. During normal operation of the automotive vehicle, the fuel tank breathes through the emissions canister. The canister may go for several hours, even days, without a purge cycle from the engine. During this time, a diffusion process known as “bleed emissions” happens inside the canister and fuel vapors are emitted from the canister. In accordance with the present invention, an external module containing carbon-coated foam material is joined with an emissions canister at the fresh air-side of the canister to prevent or substantially reduce the amount of emissions to the atmosphere. More particularly, the present invention is concerned with the emission, to the atmosphere, of residual fuel vapor contained in the air from the evaporative emissions canister during the cycle where the fuel vapor is being emitted from the fuel tank and subsequently adsorbed in the adsorbent material contained in the evaporative emissions canister

Environmental regulations imposed on the automotive industry, by the environmental Protection Agency require that automotive vehicles such as gasoline and diesel powered passenger cars and trucks have on board hydrocarbon emissions controls to prevent or limit the amount of hydrocarbon pollutants expelled into the atmosphere. Such hydrocarbon pollutants are a major contributor to smog formations and contribute to the depletion of the ozone layer in our atmosphere. As a result of government mandates, automotive manufacturers are constantly being challenged to find better and more efficient ways to prevent or reduce the emissions of hydrocarbon fuel vapors and other pollutants into the atmosphere. Such emissions can be controlled by canister systems that employ carbon, preferably activated carbon, to adsorb and hold the hydrocarbon vapors. The adsorbed hydrocarbon vapor is periodically desorbed from the carbon by drawing fresh air into the carbon bed to displace the hydrocarbon fuel vapor. The displaced fuel vapor is then passed to the engine where it is consumed. The renewed carbon can then adsorb additional hydrocarbon fuel vapor from the fuel system while the air is returned to the atmosphere through the vent side of the canister.

Currently, fuel systems employed in the automotive industry employ evaporative emissions canister having an inlet port for receiving fuel vapor from the fuel tank where the fuel vapor is adsorbed on an adsorbent material and stored until such time the stored fuel vapor is returned to the fuel tank or, preferably, directed to the engine where it is consumed. Examples of evaporative emissions canisters are described in a number of U.S. Patents and Patent Applications such as U.S. Pat. Nos. 4,203,401 to Kingsley et al.; 4,658,796 To Yoshida et al.; 4,683,862 to Formuto et al.; 5,119,791 to Gifford, et al.; 5,408,977 to Cotton; 5,924,410 to Dumas et al.; 5,957,114 to Johnson et al.; 6,136,075 to Bragg et al.; 6,237,574 to Jamrog et al.; 6,540,815 to Hiltzik et al.; and RE38, 844 to Hiltzik et al., and U.S. pat. appln. Nos. Nos. 2005/0061301 to Meiller; 2005/0123458 to Meiller; and 2006/0065252 to Meiller. U.S. Pat. No. 6,540,815 to Hiltzik, et al. teaches the use of carbon coated polymeric foams integrally disposed in an emissions canister wherein the carbon foam uses a torturous path concept to perform its function and uses carbon that is at a 37 to 42 grams per liter working capacity.

In prior art evaporative emission canisters, the amount of fuel vapor that can be contained in the canister is finite and dependent upon the amount and adsorbent capability characteristics of the adsorbent material contained in the canister. Furthermore, during the adsorption stage where the fuel vapor is adsorbed in the adsorbent material, the effluent air being emitted to the atmosphere includes a relatively significant amount of residual fuel vapor which is also emitted into the atmosphere Therefore, there is a need in the industry for an evaporative emissions system wherein the effluent air emitted to the atmosphere from the canister is free or substantially free from any residual fuel vapor.

### SUMMARY OF THE INVENTION

It has been found that a carbon-coated reticulated foam material disposed in a housing module and employed externally in the fresh air line of an emissions canister effectively prevents the emission of any fuel vapor molecules through the carbon-coated reticulated foam material while allowing air molecules to pass freely therethrough. Furthermore, it has been found that the use of an external module containing the carbon-coated, reticulated foam material in conjunction with a separate emissions canister not only substantially reduces the emission of fuel vapors to the atmosphere, but the use of the external auxiliary module also increases the efficiency of the adsorbent material in the emissions canister allowing a substantial reduction in the required size of the emissions canister. More specifically, the evaporative emissions canister of the present invention incorporates the carbon-coated reticulated material on the vent or fresh air side of the evaporative emissions canister in the vent or fresh air inlet/outlet port. By installing the carbon-coated reticulated material at the vent or fresh air inlet/outlet port, the external housing containing the carbon-coated reticulated material allows the entire adsorbent bed to be utilized for adsorbing fuel vapor as opposed to prior canisters which effectively utilize only a portion of the adsorbent material contained in the canister for the purpose of adsorbing the fuel vapor. In conventional canisters, a portion of the adsorbent material is used as a buffer on the vent side of the canister. Accordingly, prior devices do not effectively utilize the entire capacity of the adsorbent bed.

In accordance with the present invention, the use of an external auxiliary housing prevents all or substantially all of the fuel vapor molecules from escaping into the atmosphere while improving the efficiency of the adsorbent material in the emissions canister, thereby reducing the size requirements for the emissions canister and providing increased flexibility in the overall configuration of the emissions system due to the use of separate and smaller components.

Accordingly, it is a primary object of this invention to provide an improved evaporative emissions system, which incorporates a carbon-coated foam material in a housing external with respect to the evaporative emissions canister wherein the full capacity of the adsorbent material can be effectively utilized.

It is another object of the invention to provide an evaporative emissions canister that provides reduced fuel emissions to the atmosphere.

It is still another object of the invention to optimize the overall packaging of the evaporative emissions system by allowing the external housing to be more efficiently configured and located in the emissions system.

It is yet another object of the invention to provide an emissions system that can simply be added on to without the need for redesigning and revalidating the emissions canister.

It is another object of the invention to provide all of the above objects of the invention without severe complexity and economic strain.

These objects as well as other objects, features and advantages of the present invention will be apparent to those skilled in the art from the following detailed description, appended claims and accompanying drawings.

### BRIEF DESCRIPTION OF THE DRAWINGS

FIG. 1 is a schematic illustration of an evaporative emission system of a combustion engine in accordance with the present invention;

FIG. 2 is a side view of an evaporative emissions canister connected to an auxiliary canister of the evaporative emissions systems of FIG. 1;

FIG. 3 is a perspective view of the auxiliary canister of the present invention;

FIG. 4 is a side view of the auxiliary canister of the present invention having a portion of the canister removed to show the carbon-coated foam material in the auxiliary canister; and

FIG. 5 is a schematic view of the carbon-coated adsorbent material of the present invention.

### DETAILED DESCRIPTION OF THE INVENTION

The carbon-coated reticulated adsorbent material employed in the present invention exhibits appropriate physical characteristics which enables the carbon-coated, reticulated foam material to effectively prevent all or substantially all of the fuel vapors from being emitted to the atmosphere. The carbon-coated, reticulated foam material effectively prevents about 95% or more of the residual fuel vapor molecules in the air flow from being emitted to the atmosphere while allowing greater than about 99% of the air molecules to be emitted to the atmosphere. Typically, the carbon-coated, reticulated foam material of the present invention has an effective pore count of about 45 to 300 pores per inch, and preferably, about 50 to 100 pores per inch. Carbon-coated, reticulated foams are disclosed in U.S. pat. appln. No. US 2006/0205830, filed Sep. 14, 2006, the contents of which is incorporated herein by reference thereto. Accordingly, the carbon-coated reticulated material effectively prevents passage of any fuel vapor molecules through the carbon-coated reticulated material while allowing air molecules to pass freely therethrough. More specifically, the evaporative emissions canister of the present invention incorporates the carbon-coated reticulated material on the vent or fresh airside of the evaporative emissions canister in the vent or fresh air inlet/outlet port. By installing the carbon-coated reticulated material at the vent or fresh air inlet/outlet port, the external housing containing the carbon-coated reticulated material allows the entire adsorbent bed to be utilized for adsorbing fuel vapor as opposed to prior canisters which effectively utilize only a fraction of the adsorbent material contained in the canister for the adsorption of the fuel vapor. In the prior art canister, a considerable amount of the adsorbent material is used as a buffer on the vent side of the canister. Accordingly, prior devices effectively utilize only about one-half to two-thirds of the capacity of the adsorbent bed.

An evaporative emissions canister such as that described in commonly assigned U.S. patent application Ser. No. 11/592,973, filed Nov. 3, 2006, the contents of which are incorporated herein by reference thereto, can be effectively employed in the present invention to not only reduce the amount of fuel vapor pollutants such as nitrogen oxides, sulfur oxides, etc. into the atmosphere, but to substantially improve the configuration of the evaporative emissions system by installing an auxiliary housing member containing a carbon-coated reticulated material, wherein the auxiliary housing is installed in the fresh air line outside the first housing of the evaporative emissions system. In a typical installation, the external housing module containing a carbon-coated, reticulated foam material is placed in the fresh air line where the carbon-coated reticulated material permits the free flow of air from the atmosphere through the carbon-coated reticulated material disposed in the emissions canister during a purge step, and from the emissions canister, through the carbon-coated reticulated material in the external module to the atmosphere during a regeneration step, while preventing the emission of hydrocarbon fuel vapors and pollutants into the atmosphere.

As more fully described below, the evaporative emissions system of the present invention which utilizes an auxiliary housing containing a carbon-coated reticulated material in addition to a first housing which contains a conventional adsorbent material provides a more effective evaporative emissions system while also providing a more efficient configuration device for preventing or reducing the emission of fuel vapor into the atmosphere.

The canister device of the present invention may be of any physical configuration and dimension employed in the art for the prevention or reduction of hydrocarbon emissions into the atmosphere. However, for the purpose of illustration, the automotive evaporative emissions canister comprises:

(1) An evaporative emissions canister, said evaporative emissions canister comprising:
a first housing, said first housing including a circumferential side member having an inner surface and an outer surface, a top member having an inner surface and an outer surface, and a bottom member having an inner surface and an outer surface, wherein said inner surface of said circumferential side member, said inner surface of said top member and said inner surface of said bottom member form a first chamber for receiving fuel vapor from a fuel tank and a second chamber containing an adsorbent material for adsorbing said fuel vapor from said fuel tank;
a partition extending vertically downwardly from said inner surface of said top member, wherein said partition divides said second chamber containing said fuel vapor-adsorbent material into a first compartment and a second compartment;
a first tubular member operatively connected to said first port through which fuel vapor flows into said first chamber;
a first port extending outwardly from said first housing and in operable communication with said first chamber;
a second tubular member operatively connected to said second port through which fuel vapor flows from said evaporative emissions canister to an automotive engine where said fuel vapor is consumed during a purge step;
a second port extending outwardly from said first housing and in operable communication with said second chamber;
a third tubular member operatively connected to said third port in said first housing through which fresh air is admitted to said second compartment upon desorption of said fuel vapor during a purge step and for venting said air to the atmosphere at a distal end of said third tubular member during a venting step,
a third port extending outwardly from said first housing and in operable communication with said second compartment; and

(2) an auxiliary evaporative emissions canister, said auxiliary evaporative emissions canister comprising:
a second housing disposed in said third tubular member intermediate said third port in said first housing and said distal end of said third tubular member, said second housing including a circumferential side member having an inner surface and an outer surface, a first end having an inner surface and an outer surface, a second end having an inner surface and outer surface, wherein said circumferential side member, said first end and said second end define an interior of said second housing;
a fourth port in said first end of said second housing, wherein said fourth port has a first side operatively connected to said third tubular member and a second side in open communication with said interior of said second housing; and
a fifth port in said second end of said second housing, wherein said fifth port has a first side operatively connected to said third tubular member and a second side in open communication with said interior of said second housing; and

(3) a carbon-coated reticulated material disposed in the interior of said second housing, wherein said carbon-coated reticulated material prevents or reduces fuel vapor from escaping into the atmosphere.

The first housing and the second housing are connected to provide sequential contact between said first adsorbent material and said second carbon-coated reticulated material.

The adsorbent material useful in the first housing of invention may be any of the conventional materials effective to adsorb hydrocarbon materials such as fuel vapor. Preferable, the adsorbent material is carbon, and most preferably activated carbon. The carbon can be in any desired form having an effective particle size sufficient to maximize the absorbance of the fuel vapor in the canister.

The carbon-coated reticulated material comprises an organic foam material, an inorganic foam material, a fabric material, a fibrous material, a screen material, or a filter material. Preferably, the carbon-reticulated material is an organic foam material such as polyurethanes, polyethylenes, polyamides, melamines, acrylics, polyvinyl acetates, polyvinyl alcohols, ethylene-vinyl acetate copolymers, or blends thereof.

And most preferably, the carbon-coated reticulated polymeric foam material is a carbon coated polyurethane foam.

The carbon-coated reticulated material effectively prevents fuel vapor molecules from permeating through said carbon-coated reticulated foam material while allowing air molecules to permeate therethrough. Preferably, the carbon-coated reticulated material of the present invention exhibits separation characteristics which prevents the permeation of greater than about 80% of the fuel vapor molecules from passing through the carbon-coated foam material while allowing greater than about 95% of the air molecules to pass freely therethrough. Preferably, greater than about 95% of the fuel vapor molecules are retained on the carbon-coated foam material while greater than about 99% of the air molecules passes through the carbon-coated foam material.

The first housing is a unitary structure molded from a material exhibiting sufficient flexibility, fuel resistance, heat resistance, pressure resistance, weatherability, dimensional stability, and high impact strength to withstand a harsh environment associated with an automotive evaporative emissions system.

Each of the first housing and the auxiliary housing is molded as a continuous member from a polyamide, such as nylon or an aromatic polyamide, such as aramid.

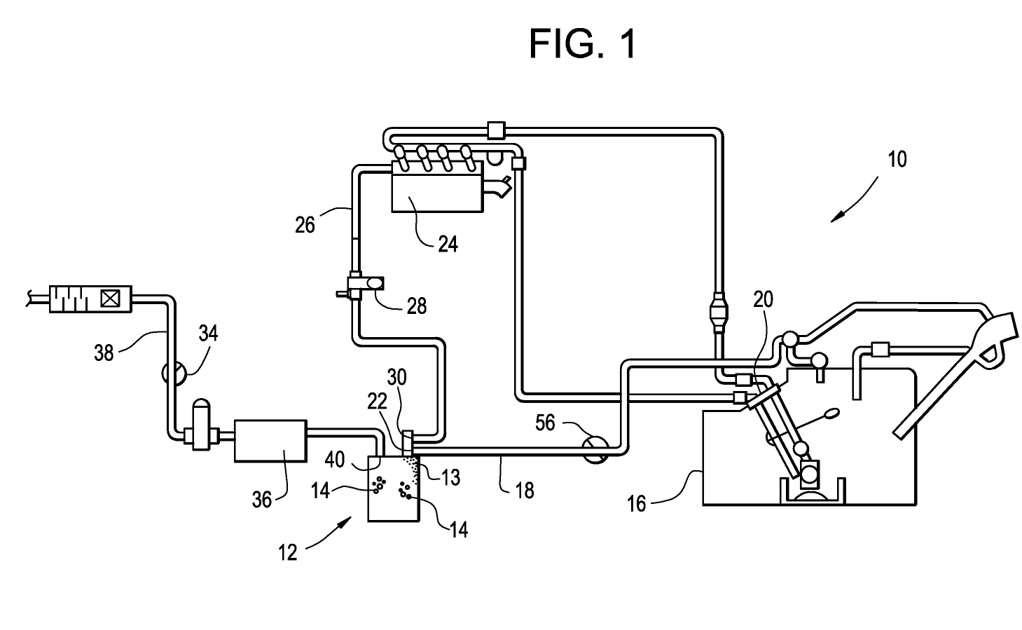

Turning now to the drawings, FIG. 1 is a schematic illustration of an evaporative emissions system for an automotive vehicle (not shown). As illustrated in FIG. 1, the evaporative emissions system 10 includes an evaporative emissions canister 12 having a housing 13 containing a bed of adsorbent material 14. Fuel vapor vented from the fuel tank 16 flows through the fuel vapor line 18 that communicates with fuel tank 16 via port 20 and with canister 12 via port 22. The fuel vapor is vented from the fuel tank 16 where it flows through fuel vapor line 18 to the canister 12, where the fuel vapor is adsorbed on the bed of adsorbent material 14. The adsorbed fuel vapor is then purged from the adsorbent material 14 as necessary by applying engine vacuum on the bed of adsorbent material 14, drawing fresh air from the atmosphere and through the adsorbent material 14 to displace the fuel vapor. The displaced fuel vapor is then fed to the engine 24 through engine vacuum line 26, and consumed during a purge step.

When the adsorbent material 14 becomes saturated with the fuel vapor, engine controller 28 commands fuel vapor valve 30 to close the fuel vapor load line 18 and the fuel vapor is desorbed from the adsorbent material 14 and drawn by vacuum through an engine vacuum controller 28 connecting engine vacuum line 26 to the engine 24 where the desorbed fuel vapor is consumed. A vacuum is created by opening the fresh air valve 34 causing fresh air from the atmosphere to be drawn into the canister 12 through the auxiliary canister 36 as a separate housing located in the fresh air line 38 outside the evaporative emissions canister 12.

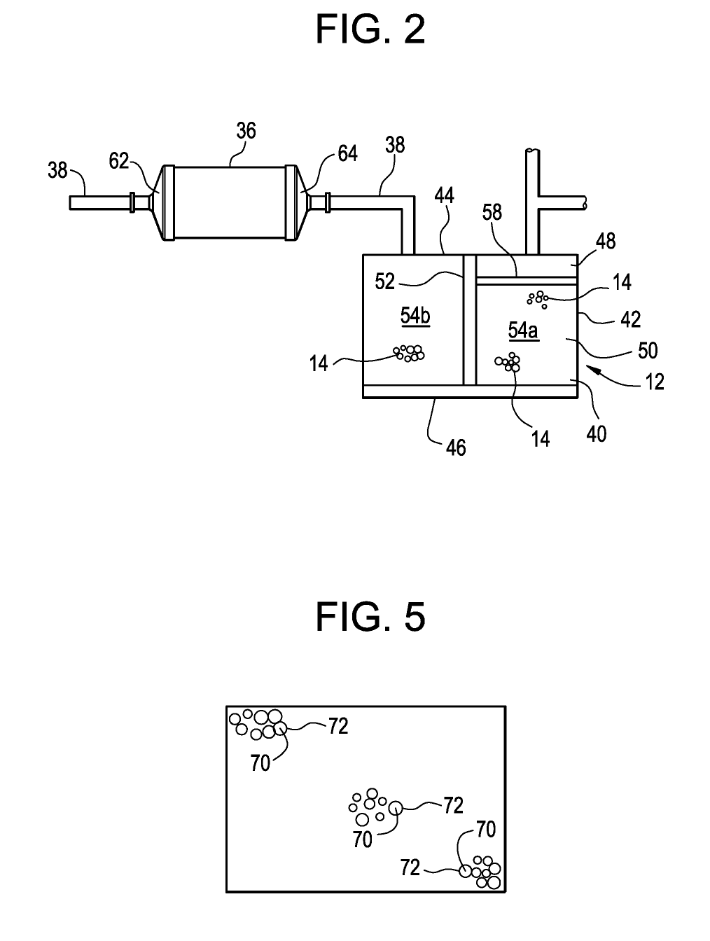

As shown in FIG. 2, the canister 12 includes a housing 40 having a side member 42, a top member 44 and a bottom member 46. The canister 12 further includes a fuel vapor-receiving chamber 48 located above the adsorbent chamber 50. The adsorbent chamber 50 includes a partition 52 that divides the adsorbent chamber into two compartments 54a and 54b, both of which contain adsorbent material 14. The adsorbent material 14 in the first compartment 54a, which is located directly below the fuel vapor-receiving chamber 48, adsorbs and stores the fuel vapor as it enters the compartment 54a. During a purge step, the fuel vapor valve is actuated to draw fresh air from the fresh air valve 34 through the second compartment 54b via fresh air port 40 where the fresh air travels through the adsorbent material 14 and around the bottom of the partition 52 displacing the fuel vapor adsorbed and stored in the compartment 54a. The displaced fuel vapor proceeds to the automotive engine 26 through engine vacuum line 26, where it is consumed. Fuel vapor entering the canister 14 through port 22 is passed into the adsorbent chamber 50, which contains the adsorbent material 14.

In order to keep the adsorbent material 14 inside the adsorbent material chamber 50, a barrier member 58 may be disposed between the fuel vapor-receiving chamber 48 and the adsorbent chamber 50 to keep the adsorbent material 14 from inadvertently escaping the adsorbent chamber 50 and entering the fuel vapor-receiving chamber 48. Typically the barrier member 58 is a porous material such as a foamed polymeric material, a fibrous material, or the like. Typically, a relatively rigid support member having one or more apertures therein to allow the fuel vapor to flow therethrough is disposed between the fuel vapor receiving chamber 48 and the adsorbent chamber 50. The bottom surface 60 of the support member includes a plurality of finger elements (not shown) extending downwardly from the bottom surface of the barrier member 58. The finger elements interconnect with the barrier member 58 to provide the barrier member 58 with a relatively flat surface having increased surface area. Also, a barrier layer and a support member such as discussed above may be placed between the adsorbent material in compartment 54b and fresh air port 40.

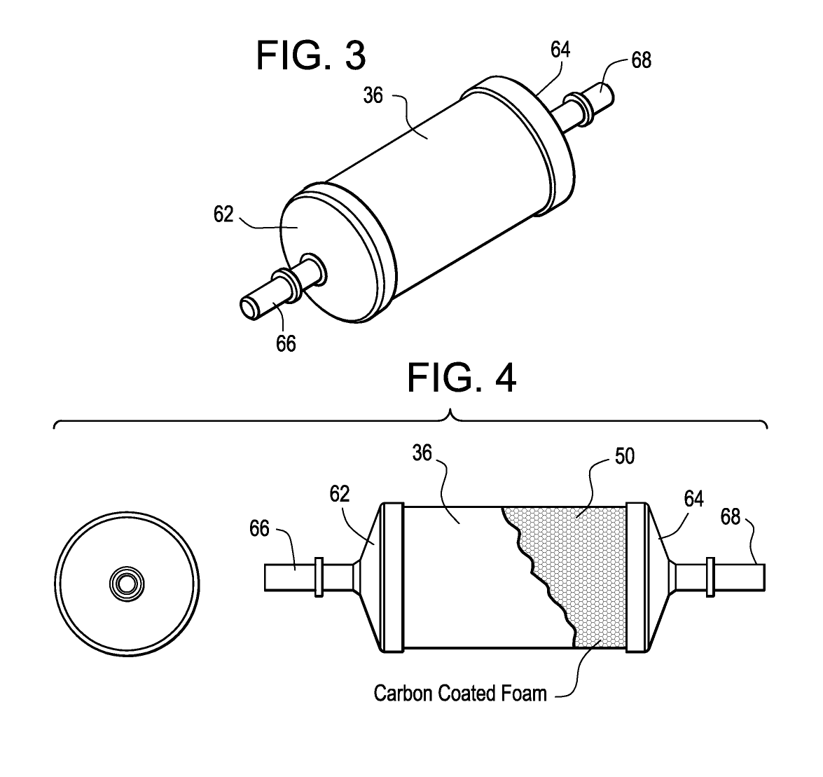

FIG. 3 shows an auxiliary canister 36 in accordance with the invention. The auxiliary canister 36 has a continuous side member 60, a first end member 62 and a second end member 64 opposite the first end member 62. Typically, the auxiliary canister 36 is formed with one end as an integral member. The other end is formed separately to provide access to the interior of the auxiliary canister 36. Once the auxiliary canister 36 is filled with the carbon-coated reticulated material, the second end is secured to the auxiliary canister by a securing means such as a threaded coupling, clamp, interlocking means, and the like. Each of the first and second end members has a tubular member 66 and 67, respectively, along the longitudinal axis of the auxiliary canister. Tubular member 66 extending outward from the first end member 62 is secured to the fresh air line 38 by a first securing means, such as a quick connect/disconnect securing means; and tubular member 68 extending outward from the second end member 64 is secured to the fresh air line 38 by a second securing means, such as a quick connect/disconnect. Such configuration allows fresh air to flow through the auxiliary canister 36 to the canister 12 during a purge step and allows the air to return through the auxiliary canister 36 and to the atmosphere. The auxiliary canister 36 containing the carbon-coated reticulated material 30 is connected to canister 12 via fresh air port 40. Upon removal of the fuel vapor from the adsorbent material 14, the fuel vapor valve 30 is opened so that additional fuel vapor from the fuel tank 16 can be transported via fuel vapor load line 18 to the canister 12 where it is adsorbed on the renewed adsorbent material 14. At the same time the air is forced back through the adsorbent material 14, through the auxiliary canister 36 containing the carbon-coated reticulated material 30 at the fresh air port 40, and through the fresh air line 38 on to the atmosphere. The fresh air valve 34 is opened and closed by the engine controller 28 allowing fresh air to enter the canister 14 during the purging step and to allow fresh air to exit the canister 12 and the auxiliary canister 36 during the adsorption step. However, the fresh air valve 34 typically remains open until routine or diagnostic steps are performed on the automotive vehicle.

FIG. 4 is a partial cross-sectional side view of the auxiliary canister 36 of the invention showing the carbon-coated reticulated material 30 disposed in the interior of the auxiliary canister 36.

FIG. 5 is an elevational view of a carbon-coated reticulated material 30. The pores 70 of the reticulated material 36 are illustrated as being coated with carbon 72.

The evaporative emissions canister of the present invention is manufactured from any material possessing the desirable properties and characteristics, such as flexibility, fuel resistance, heat resistance, pressure resistance, weatherability, dimensional stability, and high impact strength. Typically, such material is a polymeric material, more preferably, a polyamide material such as nylon or an aromatic polyamide such as aramid.

Typically, the evaporative emissions canister, including the various parts thereof, is molded in one piece to provide a continuous unitary structure thereby preventing the need for any assembly steps.

Typically, the evaporative emissions canister will include a volume compensator, as is well known in the art, located at the bottom of the canister housing to limit shifting of the adsorbent material during operation of the automotive vehicle.

As described in the aforementioned copending U.S. patent application Ser. No. 11/592,973, the fuel vapor from the fuel tank may contain a small amount of liquid fuel entrained along with the fuel vapor. If such liquid fuel is allowed to contact the adsorbent material in the evaporative emissions canister, the effectiveness of the adsorbent material may be severely diminished. Therefore, the canister of the aforementioned copending application contains provisions for a liquid-fuel trap to be integrally incorporated into the canister directly above the adsorbent chamber. Such canister would find similar utility in the present application. In those instances where liquid fuel is entrained with the fuel vapor into the evaporative emissions canister, such liquid fuel may be separated from the fuel vapor by a liquid-fuel trap where such liquid fuel remains until it is evaporated and passed on the engine along with the desorbed fuel vapor from the adsorbent material where it is consumed. A more detailed description of a liquid fuel trap is set forth in the aforementioned copending U.S. patent application Ser. No. 11/592,973, filed Nov. 3, 2006.

While the present invention has been fully illustrated and described in detail, other designs, modifications and improvements will become apparent to those skilled in the art. Such designs, modifications and improvements are considered to be within the spirit of the present invention, the scope of which is determined only by the scope of the appended claims.

What is claimed is:

1. An evaporative emissions system, said evaporative emissions system comprising:
(a) a first housing defining an emissions canister, said first housing comprising:
(1) a fuel vapor-receiving chamber for receiving fuel vapor from a fuel tank;
(2) a first tubular member extending from said first housing and in operable communication with said fuel vapor-receiving chamber, said first tubular member providing a passage through which said fuel vapor having flows into said fuel vapor-receiving chamber;
(3) a first port in said first housing, said first port providing open communication between said vapor-receiving chamber and said first tubular member;
(4) a fuel vapor adsorbing chamber adjacent said vapor-receiving chamber, said vapor-adsorbing chamber containing a fuel vapor adsorbing material disposed therein for adsorbing fuel vapor flowing thereto from said vapor-receiving chamber;
(5) a partition member extending partially into said fuel vapor adsorbent chamber from a top portion of said housing, wherein said fuel vapor adsorbent chamber is divided into a first compartment and a second compartment;
(6) a second tubular member extending from said first housing and in operable communication with said first compartment of said fuel-receiving chamber, said second tubular member providing a passage through which fuel vapor flows from said first compartment of said first compartment of said fuel-adsorbing chamber to an automotive engine where said fuel vapor is consumed;
(7) a second port in said housing, said second port providing open communication between said first compartment of said fuel vapor adsorbing chamber and said second tubular member;
(8) a third tubular member extending from said first housing, said third tubular member providing a passage through which fresh air is admitted to said second compartment of said fuel-adsorbing chamber during a purging step, and through which air containing residual fuel vapor from said second compartment of said fuel-adsorbing chamber is vented to the atmosphere in a venting step; and
(9) a third port in said first housing, said third port providing open communication between said second compartment of said fuel vapor-adsorbent chamber and said third tubular member;
(b) a second housing disposed in said third tubular member extending from said first housing, said second housing comprising:
(1) a circumferential side member having an inner surface and an outer surface;
(2) a first end member having an inner surface and an outer surface;
(3) a second end member having an inner surface and outer surface, wherein said inner surface of said circumferential side member, said inner surface of said first end member and said inner surface of said second end member define an interior of said second housing;
(4) a fourth port in said first end member of said second housing, wherein said fourth port has a first side operatively connected to a first end of said third tubular member and a second side in open communication with said interior of said second housing through a first opening in said first end of said second housing; and
(5) a fifth port in said second end member of said second housing, wherein said fifth port has a first side operatively connected to a second end of said third tubular member and a second side in open communication with said interior of said second housing through a second opening in said second end of said housing; and
(c) a carbon-coated, reticulated foam disposed in the interior of said second housing, wherein said carbon-coated, reticulated foam prevents or reduces fuel vapor from said first compartment of said fuel adsorbing-chamber from escaping into the atmosphere, Wherein said second housing is external with respect to said first housing.

2. The system of claim 1 wherein said first housing and said second housing are connected to provide sequential flow of said air containing residual fuel vapor from said adsorbent material in said first compartment of said fuel-adsorbing chamber to said carbon-coated, reticulated foam during said venting step, and said fresh air from said carbon-coated, reticulated foam to said fuel vapor-adsorbing material in said first compartment of said fuel-adsorbing chamber.

3. The system of claim 1 wherein said carbon-coated, reticulated foam is an organic foam material.

4. The system of claim 3 wherein said carbon-coated, reticulated foam is a polymeric selected from the group consisting of polyurethanes, polyethylenes, polyamides, melamines, acrylics, polyvinyl acetates, polyvinyl alcohols, ethylene-vinyl acetate copolymers, or blends thereof.

5. The system of claim 4 wherein said carbon-coated, reticulated polymeric foam material is a polyurethane.

6. The system of claim 1 wherein said carbon-coated, reticulated foam effectively extracts greater than about 95% of residual fuel vapor from said air containing said residual fuel vapor passing through said carbon-coated, reticulated foam.

7. The system of claim 1 wherein said first housing is a unitary structure molded from a material exhibiting sufficient flexibility, fuel resistance, heat resistance, pressure resistance, weatherability, dimensional stability, and high impact strength to withstand a harsh environment associated with an automotive evaporative emissions system.

8. The system of claim 1 wherein said first housing is molded from a polyamide or a polyolefin.

9. The system of claim 8 wherein said first housing is molded from nylon.

10. The system of claim 1 wherein said fuel adsorbent material disposed in said first chamber comprises carbon.

11. The system of claim 10 wherein said carbon is activated carbon.

12. The system of claim 1 wherein said first chamber for receiving said fuel vapor from said fuel tank further comprises a liquid-fuel vapor trap disposed therein for trapping and storing liquid fuel entrained along with said fuel vapor from said fuel tank.

13. In an automotive evaporative emission system for preventing or reducing fuel vapor to the atmosphere, wherein said automotive evaporative emissions system includes:
(a) a first housing defining an evaporative emissions canister having disposed therein a carbon adsorbent material for adsorbing fuel vapor emitted from a fuel tank and transmitting said adsorbed fuel vapor to an automotive combustion engine during a purge step wherein said fuel vapor is consumed, and discharging air having residual fuel vapor therein to the atmosphere, the improvement wherein said evaporative emissions system further comprises:
(b) a second housing wherein said second housing is external with respect to said first housing, said second housing comprising:
(1) a circumferential side member having an inner surface and an outer surface;
(2) a first end member having an inner surface and an outer surface;
(3) a second end member having an inner surface and outer surface, wherein said inner surface of said circumferential side member, said inner surface of said first end member and said inner surface of said second end member define an interior of said second housing;
(4) a fourth port in said first end member of said second housing, wherein said fourth port has a first side operatively connected to a first end of said third tubular member and a second side in open communication with said interior of said second housing through a first opening in said first end of said second housing; and
(5) a fifth port in said second end member of said second housing, wherein said fifth port has a first side operatively connected to a second end of said third tubular member and a second side in open communication with said interior of said second housing through a second opening in said second end of said housing; and
(c) a carbon-coated, reticulated foam disposed in the interior of said second housing, wherein said carbon-coated, reticulated foam prevents or reduces fuel vapor from said first compartment of said fuel adsorbing-chamber from escaping into the atmosphere,

14. The system of claim 13 wherein said carbon-coated reticulated foam effectively extracts greater than about 95% of residual fuel vapor from said air containing said residual fuel vapor passing through said carbon-coated, reticulated foam.

15. The system of claim 13 wherein said second housing is a unitary structure molded from a material exhibiting sufficient flexibility, fuel resistance, heat resistance, pressure resistance, weatherability, dimensional stability, and high impact strength to withstand a harsh environment associated with an automotive evaporative emissions system.

16. The system of claim 15 wherein said second housing is molded from a polyamide or a polyolefin.

17. The system of claim 16 wherein said second housing is molded from nylon.

18. A method for preventing or reducing emission of fuel by-products from an automotive vehicle into the atmosphere, said method comprising:
providing an evaporative emissions canister between a fuel tank and an internal combustion engine, wherein said evaporative emissions canister comprises:
(a) a first housing defining an emissions canister, said first housing comprising:
(1) a fuel vapor-receiving chamber for receiving fuel vapor from a fuel tank;
(2) a first tubular member extending from said first housing and in operable communication with said fuel vapor-receiving chamber, said first tubular member providing a passage through which said fuel vapor having flows into said fuel vapor-receiving chamber;
(3) a first port in said first housing, said first port providing open communication between said vapor-receiving chamber and said first tubular member;
(4) a fuel vapor adsorbing chamber adjacent said vapor-receiving chamber, said vapor-adsorbing chamber containing a fuel vapor adsorbing material disposed therein for adsorbing fuel vapor flowing thereto from said vapor-receiving chamber;
(5) a partition member extending partially into said fuel vapor adsorbent chamber from a top portion of said housing, wherein said fuel vapor adsorbent chamber is divided into a first compartment and a second compartment;
(6) a second tubular member extending from said first housing and in operable communication with said first compartment of said fuel-receiving chamber, said second tubular member providing a passage through which fuel vapor flows from said first compartment of said first compartment of said fuel-adsorbing chamber to an automotive engine where said fuel vapor is consumed;
(7) a second port in said housing, said second port providing open communication between said first compartment of said fuel vapor adsorbing chamber and said second tubular member;
(8) a third tubular member extending from said first housing, said third tubular member providing a passage through which fresh air is admitted to said second compartment of said fuel-adsorbing chamber during a purging step, and through which air containing residual fuel vapor from said second compartment of said fuel-adsorbing chamber is vented to the atmosphere in a venting step; and
(9) a third port in said first housing, said third port providing open communication between said second compartment of said fuel vapor-adsorbent chamber and said third tubular member;
providing a second housing disposed in said third tubular member extending from said first housing, said second housing comprising:
(1) a circumferential side member having an inner surface and an outer surface;
(2) a first end member having an inner surface and an outer surface;
(3) a second end member having an inner surface and outer surface, wherein said inner surface of said circumferential side member, said inner surface of said first end member and said inner surface of said second end member define an interior of said second housing;
(4) a fourth port in said first end member of said second housing, wherein said fourth port has a first side operatively connected to a first end of said third tubular member and a second side in open communication with said interior of said second housing through a first opening in said first end of said second housing; and
(5) a fifth port in said second end member of said second housing, wherein said fifth port has a first side operatively connected to a second end of said third tubular member and a second side in open communication with said interior of said second housing through a second opening in said second end of said housing;
providing a carbon-coated, reticulated foam disposed in the interior of said second housing, wherein said carbon-coated, reticulated foam prevents or reduces fuel vapor from said first compartment of said fuel adsorbing-chamber from escaping into the atmosphere; and providing an auxiliary housing containing a carbon-coated reticulated material, wherein said carbon-coated reticulated foam effectively extracts greater than about 95% of residual fuel vapor from said air containing said residual fuel vapor passing through said carbon-coated, reticulated foam; and
installing said auxiliary evaporative emissions canister in said third tubular member extending from said first housing wherein said auxiliary housing is in operable communication with said third port wherein said carbon-coated reticulated material in said auxiliary canister sequentially provides free flow of fresh air from the atmosphere to the evaporative emissions canister during a purge step wherein fuel vapor is desorbed from said adsorbent material in said evaporative emissions canister, and free flow of air in an air/fuel vapor mixture from said evaporative emissions canister to the atmosphere in a vent step, said carbon-coated material separating said fuel vapor from said air/fuel vapor mixture and returning said fuel vapor to said evaporative emissions canister.
Wherein said second housing is external with respect to said first housing.

19. The method of claim 18 wherein said carbon-coated reticulated material is an organic foam material.

20. The method of claim 18 wherein said carbon-coated reticular material is a polyurethane foam.
